(19) United States
(12) Patent Application Publication
(10) Pub. No.: US 2007/0236913 A1
(43) Pub. Date: Oct. 11, 2007

(54) Lighting Process And Mechanism

(75) Inventors: Jean-Jacques Caillaba, Jouques (FR); Marc Flogny, Carnoux (FR)

Correspondence Address: FITCH EVEN TABIN AND FLANNERY, 120 SOUTH LA SALLE STREET, SUITE 1600, CHICAGO, IL, 60603-3406, US

(73) Assignee: Rain Bird Europe, S.A.R.L., Aix en Provence Cedex (FR)

(21) Appl. No.: 11/278,870

(22) Filed: Apr. 6, 2006

(51) Int. Cl. F21V 33/00; F21V 23/04; F21L 13/02; F21L 4/00; F21V 7/00

(52) U.S. Cl. 362/96; 362/192; 362/247

(57) ABSTRACT

A lighting mechanism is provided for fastening to a sprinkler body that includes a power supply, an illumination module including a source of light located in a fully watertight compartment, a controller, and a fastener for mounting the illumination module to a sprinkler. The lighting mechanism may also include a device in communication with a separate remote control station to control the source of light. The remote control station may also include a programmer for varying the lighting durations of the various sources of light and a sensor such that the sources of light may be illuminated according to a signal issued by the sensor.

### FIELD OF THE INVENTION

This invention relates to a lighting process and mechanism, and, in particular, to the combination of a lighting system with a sprinkler.

### BACKGROUND OF THE INVENTION

In cases where it is intended to place a light marking or light a lawn or a piece of land, whether public or private, it is a present imperative to provide, for each marker or lighting source, a rather bulky and expensive mechanical stand. In the absence of such support, the markers or lighting sources would risk being buried in the ground within a few weeks or months. Moreover, the sets including the marker and the stand are not completely watertight and do not provide a guarantee against the formation of vapour in certain cases.

### BRIEF DESCRIPTION OF THE DRAWINGS

FIG. 1 is a schematic view showing a first mode of producing the lighting mechanism forming the subject matter of this invention;

FIG. 2 is a schematic view showing a second mode of producing the lighting mechanism forming the subject matter of this invention;

FIG. 3 is a schematic view showing a third mode of producing the lighting mechanism forming the subject matter of this invention;

FIG. 4 is a schematic showing a fourth mode of producing the lighting mechanism forming the subject matter of this invention;

FIG. 5 is a flowchart showing a succession of steps for the implementation of one of the modes of production of the lighting mechanism forming the subject matter of this invention; and

FIG. 6 is an elevation view in partial cross-section showing a power supply turbine used in one mode of the mechanism forming the subject matter of this invention.

### DESCRIPTION OF THE PREFERRED EMBODIMENTS

There is provided a lighting mechanism having an electrical power supply source; a separate illumination module including a source of light located in a fully watertight compartment; a device for controlling the starting of the source of light; and a connector for fastening the illumination module to a sprinkler. Because of these features, the sprinkler supports the source of light and avoids the need for an additional support for the source of light. Moreover, when the sprinkler carries out a sprinkling, the light cast by the lighting source is distributed by the jet and the drops of water, which is an effective way to distribute light, but is also aesthetic and whimsical.

The lighting mechanism may also include a device used for communicating with a remote control station located in a distant location. Such station being adapted in order to control the device used for controlling the start of the lighting source. Because of these features, the remote control station may, from a distant location, start or stop each of the sources of light placed on a piece of land.

In another embodiment, the lighting mechanism also includes a remote control station adapted to independently control the start of a large number of illumination modules. The remote control station can start gradually, successively or simultaneously the sources of light located on a piece of land, for instance, in order to take into account nightfall or to mark the direction of a movement on the piece of land. The remote control station may include a programmer scheduling the lighting periods of the various sources of light. The lighting periods may be programmed, e.g., according to the hour, day, sprinkling periods or a light show. The programmer may also schedule the sprinkling periods such that the sprinkling period and the sprinkling times may be coordinated.

The remote control station may also include at least a signal input from a sensor measuring a physical quantity or predetermined input and controls the start of the sources of light according to the signal issued by each such sensor. The remote control station, therefore, may include at least one motion sensor and controls the start of the sources of light according to the signal issued by each such motion sensor. The remote control station may also include at least an audio sensor and controls the start of the sources of light according to a signal issued by the audio sensor. Therefore, the lighting periods may be set according to physical quantities, such as ambient lighting, the presence of a passer-by, or any music.

In another embodiment, the device used for controlling the start of the source of light is adapted to recognize at least one identification code. The remote control station is adapted in order to transmit, along with each instruction for the start, modulation or extinction of the lights, at least one identification code for the individual or collective control of devices used for controlling the start of the lighting sources. Therefore, the remote control of the sources of light by the remote control station is simplified.

In another aspect, the communication device is adapted to communicate with the remote control station on a wireless support. As a result, it is not necessary to provide for a cable network to ensure the remote control of the sources of light. In one form, the communication device is adapted to communicate with the remote control station through a carrier current via a conductive wire.

In another embodiment, an electrical network ensuring the supply of the sources of light provides, in addition, for the remote control of the start, dimming or extinction of the sources of light. For instance, the power supply system may include a battery, a solar panel, or a turbine powered by the sprinkling water. As a result, each lighting mechanism is autonomous.

In another embodiment, the fastening device is adapted to maintain the source of light in a predetermined position around the sprinkler. In one configuration, for example, the flow of water is lit around its edge. In another configuration, the source of light abuts the principal sprinkling water flow. Therefore, the lighting may be spread by the water flow in the same manner as in an optical fiber. In yet another configuration, the source of light is steered towards a sprinkler, with which it is not mechanically linked, to generate a rainbow in the droplets scattered by such sprinkler.

In another aspect, a method of providing light includes fastening a source of light to a sprinkler; connecting the source of light to an electrical power source; and controlling the start of the source of light.

The marking or illumination, which takes the form of dots of white or coloured light, and the public or private lighting are, in the entire description, referred to by the word “lighting” that may only be differentiated by the intensity of the distributed light. Herein, the terms “address” and “identification code” are used indifferently.

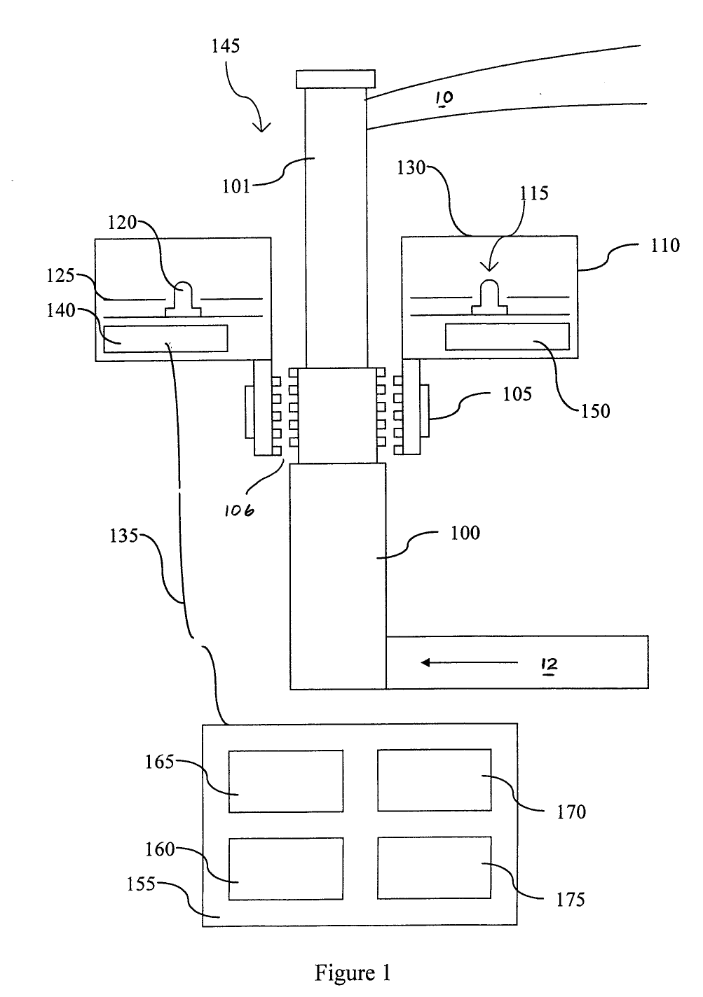

More specifically, FIG. 1 shows a first embodiment of the lighting mechanism 145 which includes the following elements, supported by a sprinkler 100: an illumination module including a clamp collar 105, a housing or an annular elastomer support 110, a crown 115 of electrically lit diodes (i.e., LEDs) 120, a reflector 125, a glazing 130, a supply cable 135, a communication device 140 linked to the supply cable 135, and a lighting control device 150. The lighting mechanism 145 also includes a remote control station 155, linked to the supply cable 135 and including a programmer 160, a user interface 165, an interface for inputting programming data 170 and signal inputs for sensors 175.

The sprinkler 100 is of a known type, i.e., the “turbine” type or a “nozzle tip” type. The sprinkler 100 includes a head 101 that is raised during the sprinkling 10, under the effect of the sprinkling water pressure 12. The clamp collar 105 allows for a solid fastening resistant against minor vandalism. The clamp collar 105 makes it possible to maintain the annular elastomer support 110 on the sprinkler's body 100. The elastomer support 110 and the sprinkler's body 100 have, facing each other, lateral surfaces adapted in order to prevent disassembly by pulling on the lighting mechanism, so long as the clamp collar 105 is tightened. For instance, the lateral surfaces facing each other include prongs or annular bumps 106.

The elastomer support 110, integrated into the lighting mechanism, makes it possible to hang the mechanism quickly and easily. The anti-vandalism clamp collar 105 makes it possible to ensure a secure installation of the lighting mechanism on the sprinkler.

The elastomer support 110, along with the glazing 130, define an inner annular area surrounding the sprinkler, i.e., an inner area around a fully watertight compartment in which are located the crown 115 of electrically lit diodes 120, the reflector 125, the communication device 140 and the lighting control device 150. The glazing 130 is, at least in part, transparent. The glazing 130 may be tinted and/or matte according to the intended visual effect. For instance, the glazing 130 is made of glass or a plastic material, such as polycarbonate, etc.

The reflector 125 has a reflecting area pierced with holes which permit the electrically lit diodes 120 to pass through above this reflecting surface area. For instance, the reflector is made of sheet iron, chromated plastic or is nickel-faced.

The crown 115 of electrically lit diodes 120 is power supplied through the lighting control device 150, e.g., by way of a transistor or relaying device, through the power supply cable 135, e.g., a 24-V direct or alternating current.

The electrically lit diodes 120 may have various colours and be controlled separately by the lighting control device 150 according to their colour, in order to generate visual effects having a varying colour and intensity.

Because of the simplicity of this version, the illumination sources are lit as soon as the electric current reaches the apparatus. Moreover, in this embodiment it is possible to connect several illumination modules at the same time to the same control outlet of the remote control station 155, so that, as soon as the current reaches such outlet, all illumination modules are lit simultaneously.

As a variant, the lighting control device 150 is controlled by the communication device 140, which communicates, through a carrier current, with the remote control station 155.

The mechanism's electrical wiring is very simple because of the use of a watertight electrical connector, linking the lighting mechanism to the power supply cable 135. The lighting mechanism can be installed at the same time as the sprinkling system or thereafter.

In the variant using controls transmitted by carrier current, the remote control station 155 communicates through carrier current with each of the mechanisms 145 located in a given area, by using known techniques, through the power supply cable 135. In this variant and in the embodiment shown in FIG. 1, each communication device 140 has at least one address on the communication network supported by the power supply cable 135. Each communication device 140 address may be (i) unique, i.e., each address of a communication device is different from all other addresses, or (ii) collective, in which case, several communication devices then have the same address.

In such variant, the remote control station can send individual or grouped instructions in order to vary the light intensity of each of these markers. The remote control station 155 is preferably adapted in order to control the various sprinklers 100 in a given area, by using known techniques, such as those used in programmers provided by Rain Bird Corporation, Inc.

In accordance with the same principle applied in such programmers, the programmer 160 of the remote control station 155 receives, from a user, who can, where applicable, be located in a distant location and communicate, through a communication network, such as a telephone or internet network or through the user interface 165 or the programming data input interface 170, certain instructions for programming the lighting duration of the mechanisms 145. Such instructions can depend on the value of signals originating from the sensor signal inputs 175, representing physical quantities used for measuring, e.g., ambient brightness, for spotting the presence of any individual in the area to be lit, or for identifying audio or video signals.

The programming instructions may represent light shows through gradual or successive starting, modulation, and extinction of the electrically lit diodes of the various lighting mechanisms 145.

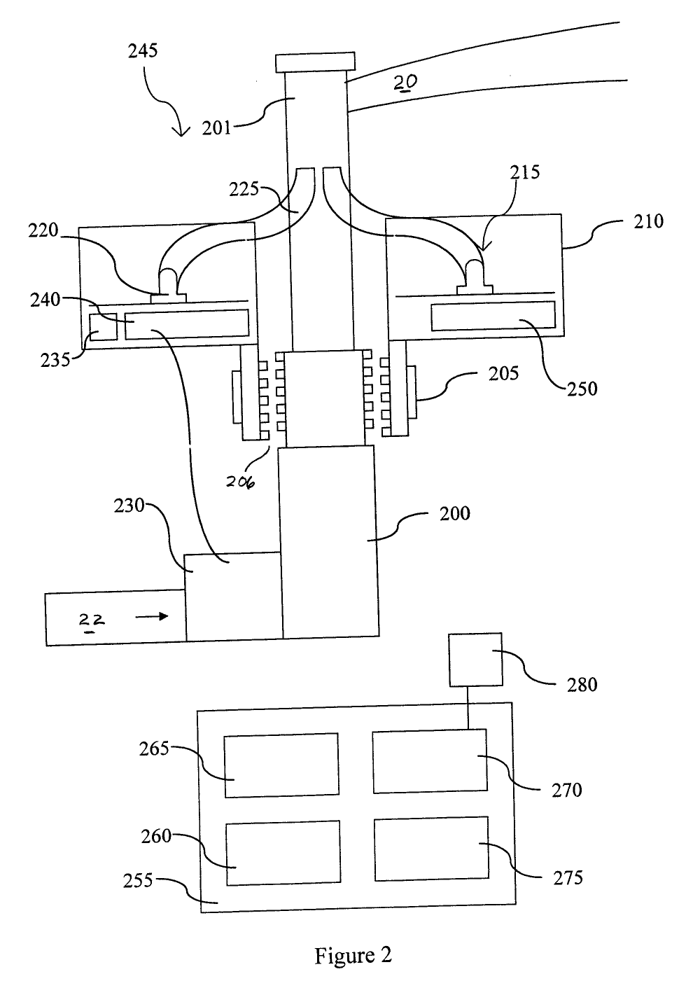

In FIG. 2, there is illustrated a second embodiment of a lighting mechanism 245. This mode includes the following items, which are supported by a sprinkler 200: an illumination module including a clamp collar 205, a housing or an annular elastomer support 210, a crown 215 of electrically lit diodes (i.e., LEDs) 220, an optical fiber beam 225, a power supply turbine 230, an antenna 235, a communication device 240 connected to the antenna 235, and a lighting control device 250. The lighting mechanism 245 also includes a remote control station 255 linked to an antenna 280 and including a programmer 260, a user interface 265, an interface for inputting programming data 270 and signal inputs for sensors 275.

The sprinkler 200 is of a known type, i.e., the “turbine” type or a “nozzle tip” type. The sprinkler 200 includes a head 201 that is raised during the sprinkling 20, under the effect of the sprinkling water pressure 22. The clamp collar 205 allows for a solid fastening resistant against minor vandalism. The clamp collar 205 makes it possible to maintain the annular elastomer support 210 on the sprinkler's body 200. The elastomer support 210 and the sprinkler's body 200 have, facing each other, lateral surfaces adapted in order to prevent disassembly by pulling on the lighting mechanism, so long as the clamp collar 205 is tightened. For instance, the lateral surfaces facing each other include prongs or annular bumps 206.

The elastomer support 210 defines an inner annular area surrounding the sprinkler 200, i.e., an inner area forming a fully watertight compartment in which are located the crown 215 of electrically lit diodes 220, the optical fiber beam 225, the antenna 235, the communication device 240 and the lighting control device 250. The optical fiber beam facing each of the electrically lit diodes 220 abuts in the centre of the outlet of the sprinkler's principal water flow 200. The optical fiber beam 225 enters the head 201 and is, at the outlet of the water flow, oriented in a direction parallel to that of the water flow, so that the light issued by the fibers is transmitted to the water flow, which, for optical purposes, has the same features as an optical fiber. When the flow is broken, the light leaves such water flow and lights the area surrounding the sprinkler 200. The optical fibers may be tinted depending on the intended visual effect.

The crown 215 of electrically lit diodes 220 is power supplied through the lighting control device 250, e.g., by way of a transistor or relaying device, through the hydroelectric power supply turbine 230 located in the water flow entering the sprinkler 200.

The electrically lit diodes 220 may have various colours and be controlled separately by the lighting control device 250, according to their colour, in order to generate visual effects having a varying colour and intensity.

The lighting control device 250 is controlled by the communication device 240, which communicates through wireless channels by way of the antennas 235 and 280 with a remote control station 255.

The remote control station 255 communicates through wireless channels with each of the mechanisms 245 located in a given area, by using known techniques, through antennas 235 and 280. In the embodiment shown in FIG. 2, each communication device 240 has at least one address on the communication network supported by wireless communication. Each communication device address 240 may be (i) unique, i.e., each address of a communication device is different from all other addresses; or (ii) collective, in which case several communication devices then have the same address.

The remote control station 255 is preferably adapted in order to control the various sprinklers 200 in a given area, by using known techniques, such as those used in programmers provided by Rain Bird Corporation, Inc.

In accordance with the same principle applied in such programmers, the programmer 260 of the remote control station 255 receives, from a user, who can, where applicable, be located at a distant location and communicate through a communication network, such as a telephone or internet network or through the user interface 265 or the programming data input interface 270, certain instructions for programming the lighting durations of the mechanisms 245. Such instructions can depend on the value of signals originating from the sensor signals' inputs 275, representing physical quantities used for measuring, e.g., ambient brightness, for spotting the presence of any individual in the area to be lit, or for identifying audio or video signals.

The programming instructions may represent light shows through gradual or successive starting, modulation, and extinction of the electrically lit diodes of the various lighting mechanisms 245.

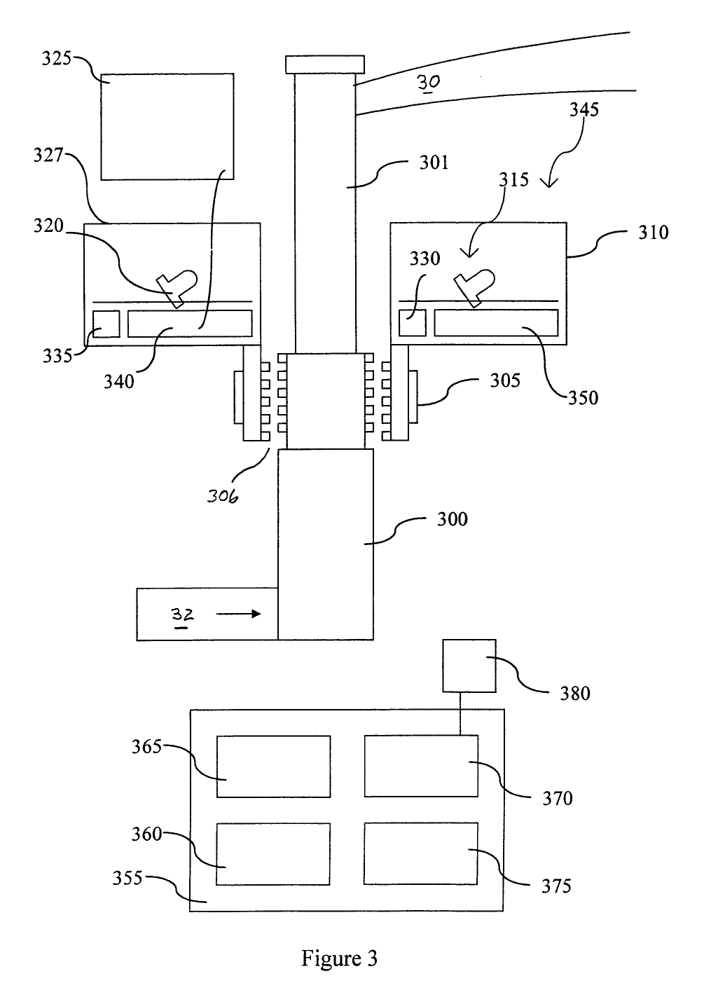

FIG. 3 shows a third embodiment of a lighting mechanism 345, which includes the following elements, supported by a sprinkler 300: an illumination module including a clamp collar 305, a housing or an annular elastomer support 310, a crown 315 of electrically lit diodes (i.e., LEDs) 320, a solar panel 325, a glazing 327, a battery 330, an antenna 335, a communication device 340 linked to the antenna 335, and a lighting control device 350. The lighting mechanism 345 also includes a remote control station 355 linked to an antenna 380 and including a programmer 360, a user interface 365, an interface for inputting programming data 370, and signal inputs for sensors 375.

The sprinkler 300 is of a known type, e.g., the “turbine” type or a “nozzle tip” type. The sprinkler 300 includes a head 301 that is raised during the sprinkling 30, under the effect of the sprinkling water pressure 32. The clamp collar 305 allows for a solid fastening resistant against minor vandalism. The clamp collar 305 makes it possible to maintain the annular elastomer support 310 on the sprinkler's body 300. The elastomer support 310 and the sprinkler's body 300 have, facing each other, lateral surfaces adapted in order to prevent disassembly by pulling on the lighting mechanism, so long as the clamp collar 305 is tightened. For instance, the lateral surfaces facing each other include prongs or annular bumps 306.

The elastomer support 310, along with the glazing 327, define an inner annular area surrounding the sprinkler 300, i.e., an inner area around a fully watertight compartment in which are located the crown 315 of electrically lit diodes 320, the antenna 335, the communication device 340, and the lighting control device 350. All of the electrically lit diodes 320 are directed parallel to one another, with an angle ranging between about 30° and about 60° in relation to the axis of the sprinkler 300 in order to light the water flow of another sprinkler with which the mechanism 345 is not mechanically linked in order to generate rainbow effects in such water flow.

The crown 315 of electrically lit diodes 320 is power supplied through the lighting control device 350, e.g., by way of a transistor or relaying device, through the battery 330 which is itself power supplied by the solar panel 325.

The electrically lit diodes 320 may have various colours and be controlled separately by the lighting control device 350, according to their colour, in order to generate visual effects having a varying colour and intensity.

The lighting control device 350 is controlled by the communication device 340, which communicates, through terrestrial channels and/or antennas 335 and 380, with the remote control station 355.

The remote control station 355 communicates through wireless channels with each of the mechanisms 345 located in a given area, according to known techniques through antennas 335 and 380. In the embodiment shown in FIG. 3, each communication device 340 has at least one address on the communication network supported by wireless communication. Each communication device address 340 may be (i) unique, i.e. that each address of a communication device is different from all other addresses; or (ii) collective, in which case several communication devices then have the same address.

The remote control station 355 is preferably adapted in order to control the various sprinklers 300 in a given area, by using known techniques, such as those used in programmers provided by Rain Bird Corporation, Inc.

In accordance with the principle applied in such programmers, the programmer 360 of the remote control station 355 receives, from a user, who can, where applicable, be located in a distant location and communicate through a communication network, such as a telephone or internet network or through the user interface 365 or the programming data input interface 370, certain instructions for programming the lighting durations of the mechanisms 345. Such instructions can depend on the values of signals originating from the sensor signal inputs 375 representing physical quantities used for measuring, e.g., ambient brightness, for spotting the presence of any individual in the area to be lit, or for identifying audio or video signals.

The programming instructions may represent light shows through gradual or successive starting, modulation, and extinction of the electrically lit diodes of the various lighting mechanisms 345.

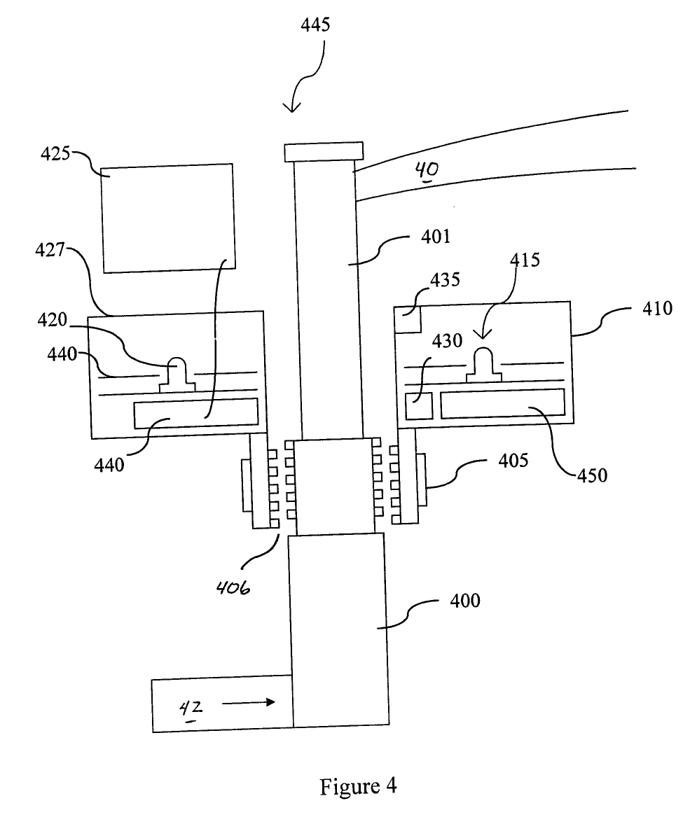

In FIG. 4, there is illustrated a fourth embodiment of the lighting mechanism 445, which includes the following elements, supported by a sprinkler 400: an illumination module including a clamp collar 405, a housing or an annular elastomer support 410, a crown 415 of electrically lit diodes (i.e., LEDs) 420, a glazing 427, a solar panel 425, a battery 430, a brightness or light sensor 435, a reflector 440, and a lighting control device 450.

The sprinkler 400 is of a known type, i.e., the “turbine” type or a “nozzle tip” type. The sprinkler 400 includes a head 401 that is raised during the sprinkling 40, under the effect of the sprinkling water pressure 42. The clamp collar 405 allows for a solid fastening resistant against minor vandalism. The clamp collar 405 makes it possible to maintain the annular elastomer support 410 on the sprinkler's body 400. The elastomer support 410 and the sprinkler's body 400 have, facing each other, lateral surfaces adapted in order to prevent disassembly by pulling on the lighting mechanism, so long as the clamp collar 405 is tightened. For instance, the lateral surfaces facing each other include prongs or annular bumps 406.

The elastomer support 410, along with the glazing 427, define an inner annular area surrounding the sprinkler 400, i.e., an inner area forming a fully watertight compartment in which are located the crown 415 of electrically lit diodes 420, the brightness sensor 435, and the lighting control device 450.

The glazing 427 is transparent, at least in part. The glazing 427 can be tinted and/or matte according to the intended visual effect. For instance, the glazing 427 is made of glass or plastic materials, such as polycarbonate, etc.

The reflector 440 has a reflecting area pierced with holes which permit the electrically lit diodes 420 to pass through above this reflecting surface area. For instance, the reflector is made of sheet iron, chromated plastic or is nickel-faced.

The crown 415 of electrically lit diodes 420 is power supplied through the lighting control device 450, e.g., by way of a transistor or relaying device, through the battery 430, which is itself power supplied by the solar panel 425, e.g., with direct current.

The electrically lit diodes 420 may have various colours and be controlled separately by the lighting control device 450, according to their colour, in order to generate visual effects having a varying colour and intensity.

The lighting control device 450 is controlled by the signal exiting the light sensor 435 in order to start the electrically lit diodes when the ambient brightness is less than a pre-determined threshold. Thus, the lighting mechanism 445 is autonomous.

As a variant, the solar panel 425 may be replaced by the turbine shown in FIG. 2. In this variant, the lighting mechanism is autonomous, and its electrical energy source is not visible and can therefore not be subject to vandalism.

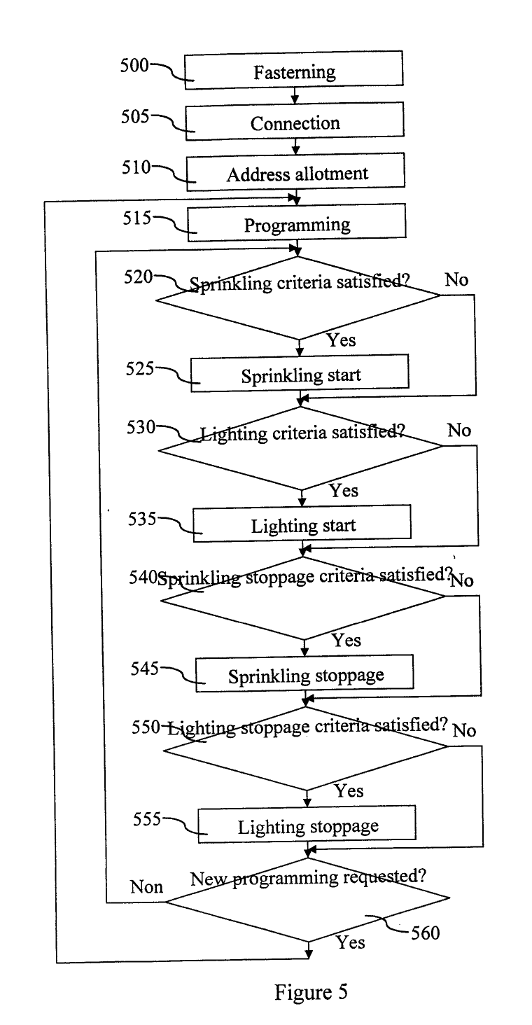

Referring to the flowchart of FIG. 5, a succession of steps for the application of various lighting modes is illustrated. The flowchart includes a step 500 for the fastening of at least one source of light to at least one sprinkler. Thereafter, during another step 505, each source of light is connected to an electrical power supply, for instance one of the electrical power supplies shown in FIGS. 1 to 4 and described in connection therewith.

During a subsequent step 510, each source of light is given at least one address, i.e., an address that is unique in the network of sources of light and an address common to other sources of light in order to form a group of sources of light sources of light forming part of the central alley, peripheral sources of light, etc.

During a subsequent step 515, it is possible to program the sprinklers' sprinkling phases and the lighting phases of the sources of light, according to criteria such as their address, dates, hours and signals from sensors measuring physical quantities.

During a subsequent step 520, it is possible to determine whether the sprinkling criteria of at least one sprinkler are satisfied. In the affirmative, during a subsequent step 525, it is possible to launch a sprinkling phase for each sprinkler in respect of which the sprinkling criteria are satisfied.

During a subsequent step 530, it is possible to determine whether the lighting criteria of at least one source of light are satisfied. In the affirmative, during a subsequent step 535, it is possible to launch a lighting phase for each source of light in respect of which the lighting criteria are satisfied.

During a subsequent step 540, it is possible to determine whether the sprinkling stoppage criteria of at least one sprinkler are satisfied. In the affirmative, during a subsequent step 545, it is possible to stop the sprinkling phase for each sprinkler in respect of which the sprinkling stoppage criteria are satisfied.

During a subsequent step 550, it is possible to determine whether the lighting stoppage criteria of at least one source of light are satisfied. In the affirmative, during a subsequent step 555, it is possible to stop the lighting phase for each source of light in respect of which the lighting stoppage criteria are satisfied.

During a subsequent step 560, it is possible to determine whether a new programming is sought e.g., through a signal originating from a user interface or a network. If so, the procedure is restarted at step 515. In the negative, the procedure is restarted at step 520.

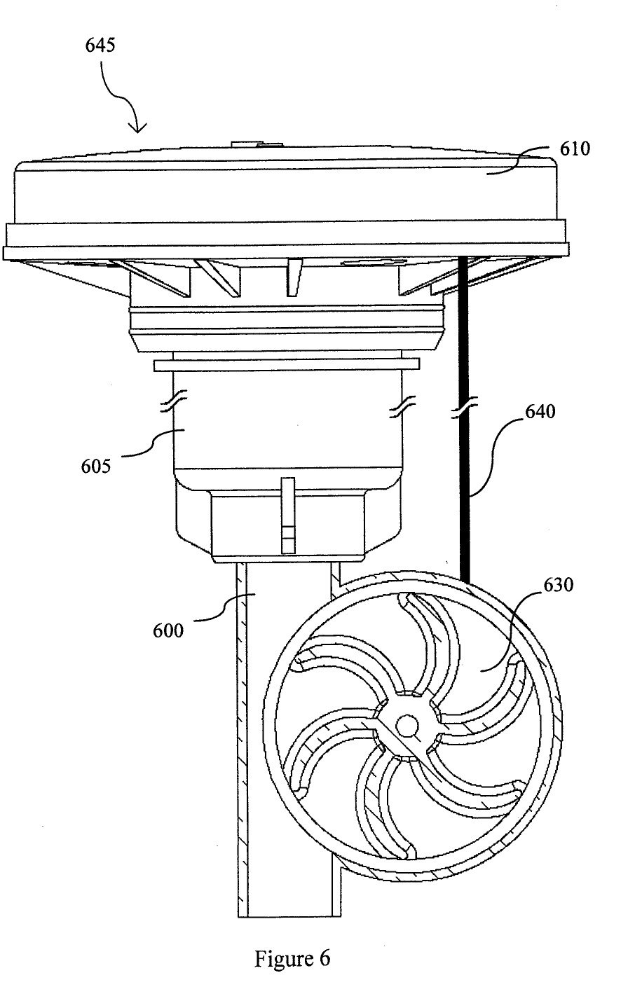

FIG. 6 shows an embodiment relying on a turbine ensuring the power supply of the lighting mechanism. This method involves the use of the following elements, supported by a sprinkler 600: a clamp collar 605, a housing or an annular elastomer support 610, a crown of electrically lit diodes not shown, a power supply turbine 630, a power supply cable 640 linking the turbine 630 to the power supply circuit not shown of the electrically lit diodes.

The hydroelectric turbine 630 is placed in a derivation circuit not shown located in the sprinkler's body. The main circuit carries the main part of the water flowing out of the sprinkler in order to water the piece of land that is to be sprinkled. The derivation circuit receives part of the sprinkling water and injects the same into the turbine 630 before such derivative sprinkling water abuts in a pressure outlet not shown watering the foot of the sprinkler.

The turbine 630 is, in one of the embodiments, a brushless motor used as a generator followed by an amplifier. The turbine 630 generates the electrical energy consumed by the lighting mechanism.

It will be understood that various changes in the details, materials, and arrangements of parts and components, which have been herein described and illustrated in order to explain the nature of the invention may be made by those skilled in the art within the principle and scope of the invention as expressed in the appended claims.

What is claimed is:

1. A lighting mechanism for an irrigation sprinkler comprising:
a housing defining a waterproof internal compartment;
a connector to removably attach the housing to a sprinkler;
a light source disposed in the internal compartment;
a controller to control operation of the light source; and
a power source for energizing the light source.

2. The lighting mechanism of claim 1 further comprising a communication device and a remote control station to communicate with the communication device in order to control at least in part operation of the light source.

3. The lighting mechanism of claim 2 wherein the remote control station is capable of independently controlling a plurality of the lighting mechanisms.

4. The lighting mechanism of claim 3 wherein the remote control station further comprises a programmable device to control at least in part operation of the light source.

5. The lighting mechanism of claim 4 wherein the control station further comprises a sensor signal input to control at least in part operation of the light source.

6. The lighting mechanism of claim 4 wherein the control station comprises a motion sensor signal input to control at least in part operation of the light source based on the presence of motion.

7. The lighting mechanism of claim 4 wherein the control station comprises an audio sensor signal input to control at least in part operation of the light source based on the presence of sound.

8. The lighting mechanism of claim 3 wherein the remote control station further comprises a programmer that programs for controlling operation of the light source and a sprinkler.

9. The lighting mechanism of claim 8 wherein the controller recognizes at least one identification code and the remote control station transmits instructions for at least starting, modulation or extraction of the light source and with each instruction the at least one identification code for individual or collective control of one or more of the plurality of the lighting mechanisms.

10. The lighting mechanism of claim 2 wherein the communication of the remote control station with the communication device is through a wireless connection.

11. The lighting mechanism of claim 2 wherein the communication of the remote control station with the communication device is through a wire.

12. The lighting mechanism of claim 11 wherein the wire supplies both power from the power source and information from the remote control station in order to control at least in part operation of the light source.

13. The lighting mechanism of claim 1 wherein the power source comprises a battery.

14. The lighting mechanism of claim 1 wherein the power source comprises a solar panel.

15. The lighting mechanism of claim 1 wherein the power source comprises a water driven turbine.

16. The lighting mechanism of claim 1 wherein the connector is capable of attaching the housing to a sprinkler in order to position the light source around a principal outlet of the sprinkler.

17. The lighting mechanism of claim 1 wherein the illumination source illuminates water emitting from a separate sprinkler.

18. The lighting mechanism of claim 1 wherein the light source engages at least a portion of water flowing through a sprinkler.

19. A method of lighting for a sprinkler comprising the steps of:
(a) fastening to a sprinkler a lighting mechanism having at least a housing defining a waterproof internal compartment and a light source disposed in the internal compartment;
(b) connecting the light source to an electrical power supply; and
(c) controlling the starting of the light source.
